(19) United States
(12) Patent Application Publication
(10) Pub. No.: US 2007/0292721 A1
(43) Pub. Date: Dec. 20, 2007

(54) Perpendicular magnetic recording medium

(76) Inventors: Andreas Klaus Berger, San Jose, CA (US); Xiaoping Bian, Saratoga, CA (US); Qing Dai, San Jose, CA (US); Hoa Van Do, Fremont, CA (US); Eric Edward Fullerton, Morgan Hill, CA (US); Bernd Heinz, San Jose, CA (US); Yoshihiro Ikeda, San Jose, CA (US); David Thomas Margulies, Salinas, CA (US); Mary Frances Minardi, Santa Cruz, CA (US); Mohammad T. Mirzamaani, San Jose, CA (US); Hal Jervis Rosen, Los Gatos, CA (US); Natacha Frederique Supper, Campbell, CA (US); Kentaro Takano, San Jose, CA (US); Min Xiao, Los Gatos, CA (US)

Correspondence Address: HITACHI GLOBAL STORAGE TECHNOLOGIES, INC., 5600 COTTLE ROAD, NHGB/0142, IP DEPARTMENT, SAN JOSE, CA, 95193, US

(21) Appl. No.: 11/789,891

(22) Filed: Apr. 25, 2007

Related U.S. Application Data
(60) Provisional application No. 60/794,961, filed on Apr. 25, 2006.

(51) Int. Cl. G11B 5/66; G11B 5/706

(52) U.S. Cl. 428/828.1; 428/828; 428/846

(57) ABSTRACT

A perpendicular magnetic recording medium including improvements to the recording layer (RL), exchange break layer (EBL), soft underlayer (SUL), overcoat (OC), adhesion layer (AL) and the combination of the layers. Advances in the RL include a cap layer. Improvements in the EBL include a multiple layer EBL.

### CROSS-REFERENCE TO RELATED APPLICATION

This patent application claims priority to a U.S. provisional patent application entitled “Perpendicular Magnetic Recording Medium” having Ser. No. 60/794,961 and a filing date of 25 Apr. 2006, which is hereby incorporated by reference herein.

### BACKGROUND OF THE INVENTION

1. Field of the Invention

This invention relates generally to perpendicular magnetic recording media, and more particularly to a disk with a perpendicular magnetic recording layer for use in magnetic recording hard disk drives.

2. Description of the Related Art

Perpendicular magnetic recording, wherein the recorded bits are stored in the generally planar recording layer in a generally perpendicular or out-of-plane orientation (i.e., other than parallel to the surfaces of the disk substrate and the recording layer), is a promising path toward ultra-high recording densities in magnetic recording hard disk drives. A common type of perpendicular magnetic recording system is one that uses a “dual-layer” medium. This type of system is shown in FIG. 1 with a single write pole type of recording head. The dual-layer medium includes a perpendicular magnetic data recording layer (RL) on a “soft” or relatively low-coercivity magnetically permeable underlayer (SUL) formed on the substrate.

One type of material for the RL is a granular ferromagnetic cobalt alloy, such as a CoPtCr alloy, with a hexagonal-close-packed (hcp) crystalline structure having the c-axis oriented generally perpendicular to the RL. The granular cobalt alloy RL should also have a well-isolated fine-grain structure to produce a high-coercivity media and to reduce intergranular exchange coupling, which is responsible for high intrinsic media noise. Enhancement of grain segregation in the cobalt alloy RL can be achieved by the addition of oxides, including oxides of Si, Ta, Ti, Nb, Cr, V, and B. These oxides tend to precipitate to the grain boundaries, and together with the elements of the cobalt alloy form nonmagnetic intergranular material.

The SUL serves as a flux return path for the field from the write pole to the return pole of the recording head. In FIG. 1, the RL is illustrated with perpendicularly recorded or magnetized regions, with adjacent regions having opposite magnetization directions, as represented by the arrows. The magnetic transitions between adjacent oppositely-directed magnetized regions are detectable by the read element or head as the recorded bits.

FIG. 2 is a schematic of a cross-section of a prior art perpendicular magnetic recording disk showing the write field H acting on the recording layer RL. The disk also includes the hard disk substrate that provides a generally planar surface for the subsequently deposited layers. The generally planar layers formed on the surface of the substrate also include a seed, adhesion or onset layer (OL) for growth of the SUL, an exchange break layer (EBL) to break the magnetic exchange coupling between the magnetically permeable films of the SUL and the RL and to facilitate epitaxial growth of the RL, and a protective overcoat (OC). As shown in FIG. 2, the RL is located inside the gap of the “apparent” recording head (ARH), which allows for significantly higher write fields compared to longitudinal or in-plane recording. The ARH comprises the write pole (FIG. 1) which is the real write head (RWH) above the disk, and a secondary write pole (SWP) beneath the RL. The SWP is facilitated by the SUL, which is decoupled from the RL by the EBL and produces a magnetic mirror image of the RWH during the write process. This effectively brings the RL into the gap of the ARH and allows for a large write field H inside the RL.

As the thickness of the RL decreases, the magnetic grains become more susceptible to magnetic decay, i.e., magnetized regions spontaneously lose their magnetization, resulting in loss of data. This is attributed to thermal activation of small magnetic grains (the superparamagnetic effect). The thermal stability of a magnetic grain is to a large extent determined by KᵤV, where Kᵤ is the magnetic anisotropy constant of the grain and V is the volume of the magnetic grain.

What is needed is an improved perpendicular magnetic recording medium that includes better recording performance and methods of manufacturing such media.

### SUMMARY OF THE INVENTION

Described are improvements to perpendicular recording media. The improvements increase the recordability and other specifications of perpendicular recording media including the SoNR and corrosion resistance. The improvements include capped media as well as improved exchange break layers. Further the improvements include methods of manufacturing the various layers of the perpendicular recording media.

For a fuller understanding of the nature and advantages of the present invention, reference should be made to the following detailed description taken together with the accompanying figures.

### BRIEF DESCRIPTION OF THE DRAWING

FIG. 1 is a schematic of a prior art perpendicular magnetic recording system.

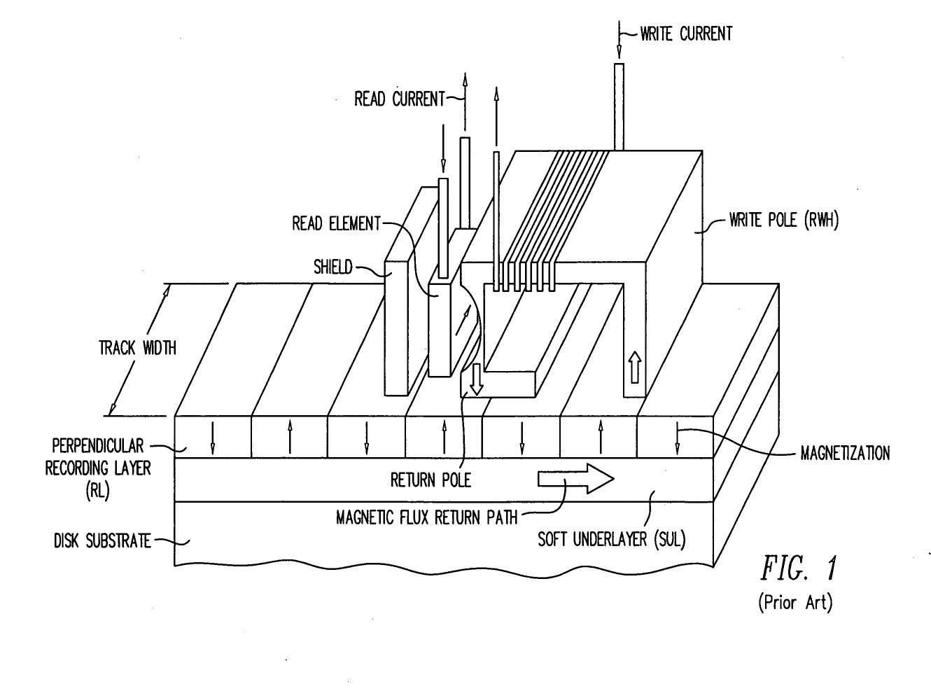

FIG. 2 is a schematic of a cross-section of a prior art perpendicular magnetic recording disk showing the write field H acting on the recording layer (RL).

FIG. 3 is a schematic of a cross-section of capped media.

FIGS. 4a-4d are graphs of write current dependence on amplitude, medium noise dependence on linear density, signal dependence on linear density and corrosion current of capped media vs. non-capped media.

FIG. 5a is a cross-section of a schematic of an embodiment of non-capped perpendicular media.

FIG. 5b is a cross-section of a schematic of an embodiment of capped perpendicular media.

FIGS. 6a and 6b are graphs of the effects of cooling on coercivity and SoNR of media.

FIG. 7 shows the dependence of the coercivity on the bias voltage applied to the disk during sputtering of the magnetic layers.

FIG. 8 show an embodiment of an EBL suitable for use with perpendicular media.

FIG. 9 is a plane view TEM image of a lower sublayer of a capped RL media.

FIG. 10 is a plane view TEM image of a cap layer of a capped RL media.

FIG. 11a and 11b are schematic representations of the RL.

FIG. 12 is a graph comparing the thermal decay of capped and non-capped media.

FIG. 13 is a graph comparing the BER of capped and non-capped media.

FIG. 14 is a graph comparing the ATI of capped and non-caped media.

FIG. 15 is four graphs showing the dependence of coercivity (Hc), switching field distribution (SFD), nucleation field (Hn) and saturation field (Hs) on thickness of a CoCrPtB cap layer.

FIG. 16 shows a comparison of SoNR performance of cap and non-cap PMR media.

### DETAILED DESCRIPTION OF THE INVENTION

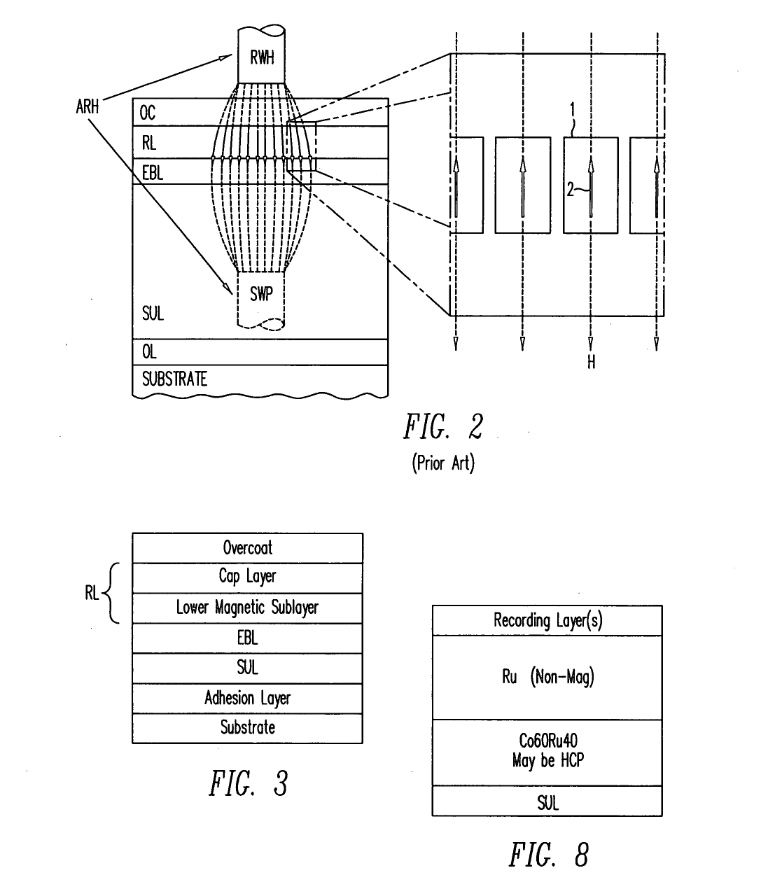

As described in FIG. 2, perpendicular media typically includes several layers. These layers include an adhesion layer (AL) (or onset layer), a soft underlayer (SUL), an exchange break layer (EBL), a recording layer (RL) and an overcoat (OC) deposited onto a substrate. These layers themselves may be comprised of multiple layers. Further, a lubricant is typically applied on top of the OC.

### Perpendicular Media Embodiments

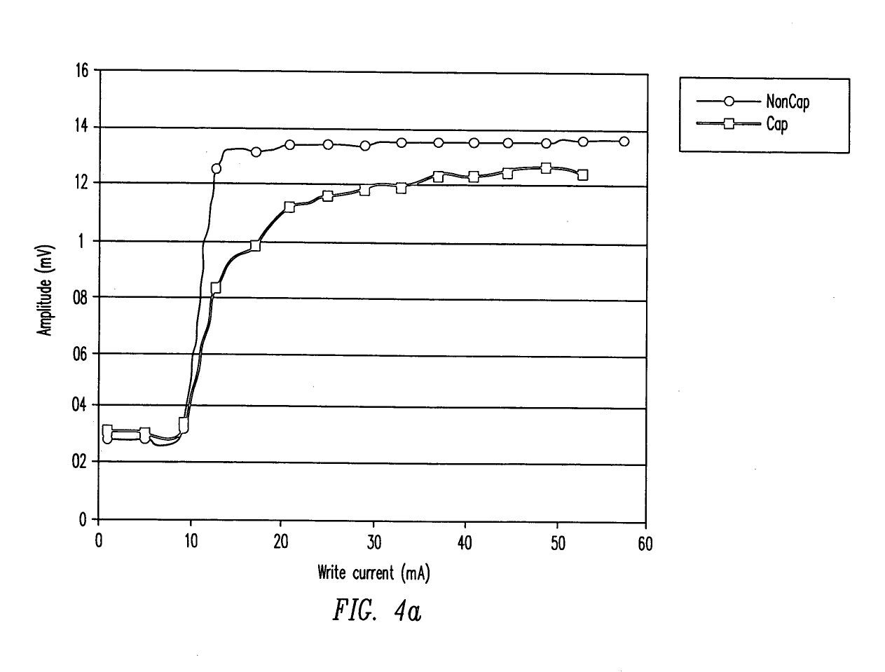

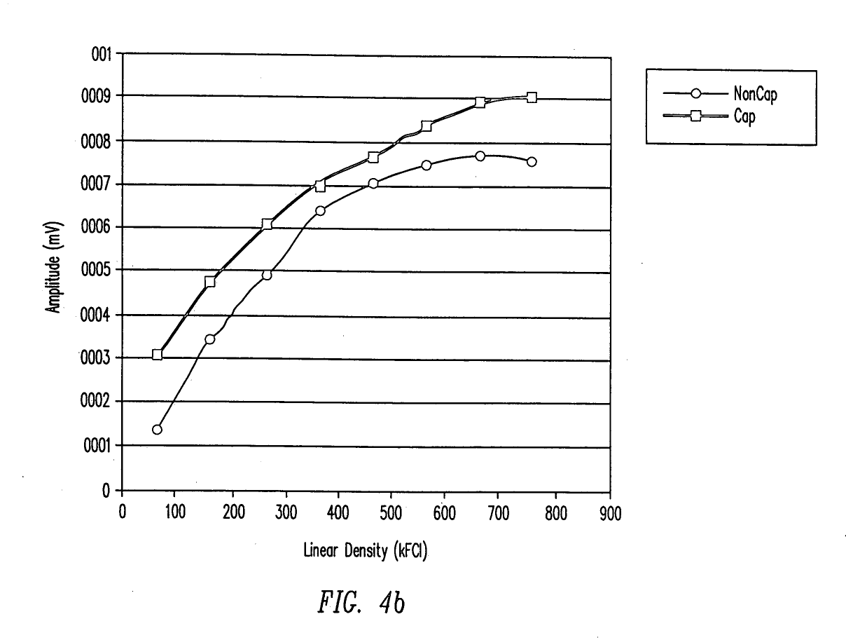

In particular, the RL may be formed in a capped structure. Such a structure is described in FIG. 3. Generally, the cap is a dense magnetic layer that provides for improved corrosion resistance and enhanced magnetic properties. The cap provides corrosion resistance using high amounts of materials that resist corrosion such as Cr and sometimes Pt. A cap including B also can improve hardness. Further, these materials lead to denser and smoother films when sputtered at low pressures. The enhanced magnetic properties are provided through the structure and composition of the cap. FIGS. 4a-4d are graphs of write current dependence on amplitude, medium noise dependence on linear density, signal dependence on linear density and corrosion current of capped media vs. non-capped media. In addition, Table 1 shows the roughness of media goes down when a cap layer is used. Four similar pieces of media are compared and the two pieces of media with the lowest roughness are those with a cap layer.

TABLE 1
AFM Roughness

| | Ru | EBL | | | | |
|---|---|---|---|---|---|---|
| Sam- | pressure | Thickness | CoCrPt | Rp-1 um | Rp-5 um | Rv-1 um |
| ples | (mTorr) | (nm) | cap | (nm) | (nm) | (nm) |
| 1 | 37 | 21 | No | 2.2 | 1.7 | 2.3 |
| 2 | 23 | 32 | No | 1.97 | 1.86 | 1.99 |
| 3 | 23 | 34 | Yes | 1.72 | 1.43 | 1.51 |
| 4 | 30 | 34 | Yes | 1.8 | 1.41 | 1.84 |

Further, the use of a cap layer also tends to lower coercivity, narrow the switching field distribution, maintain the nucleation field and lower the saturation field.

Media—NonCapped

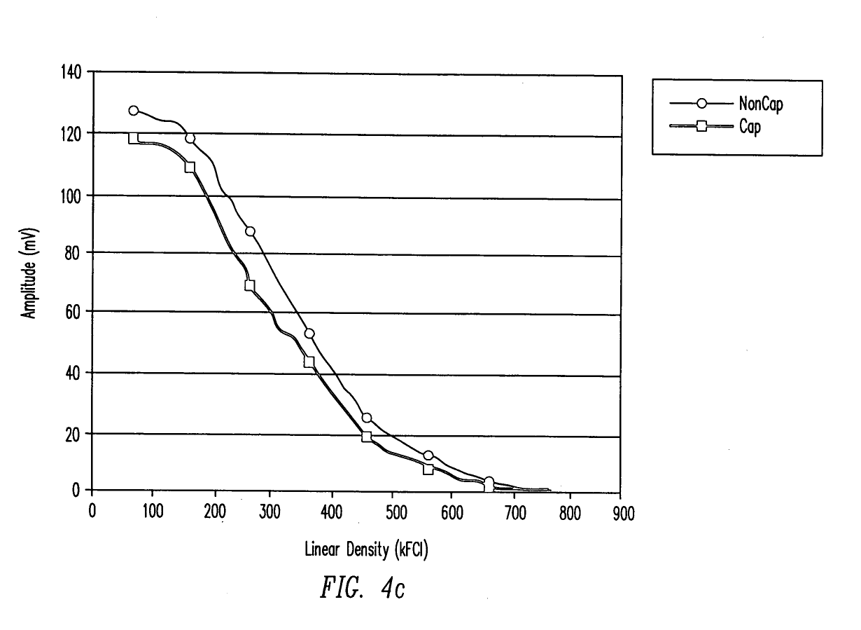

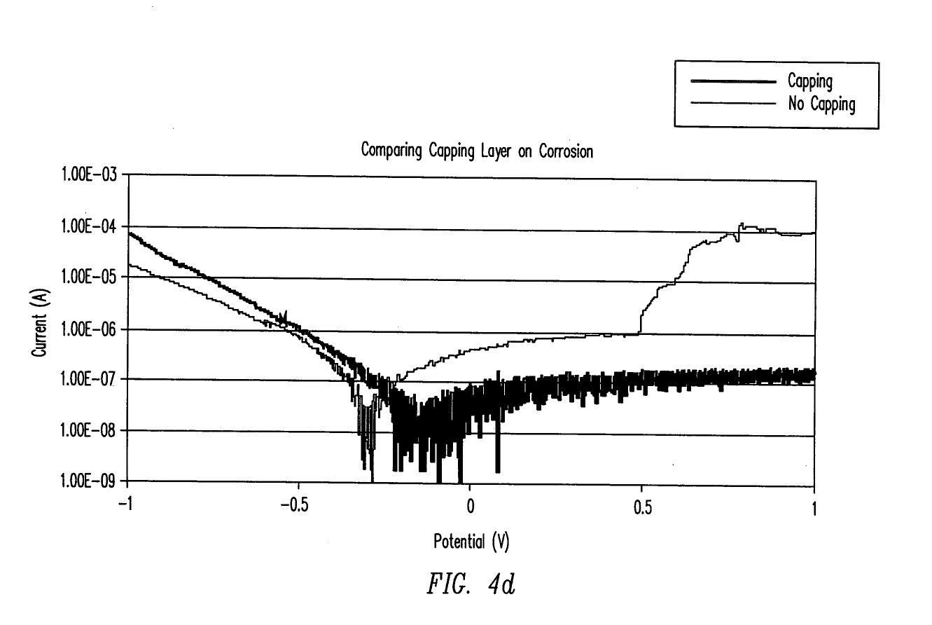

An example of non-capped media on a substrate is shown in FIG. 5a. FIG. 5a shows a perpendicular media with an AlTi adhesion layer 5 nm thick. Other adhesion layers that could be used include NiAl, NiCr and CrTi. The adhesion layer is used to keep the entire sputtered structure (SUL, EBL, RL, OC, etc.) attached to the substrate. Generally, the adhesion layer is from 2-8 nm thick and preferably 4-5 nm. The next three sublayers comprise an antiferromagneticaly coupled (AFC) soft underlayer (SUL). The bottom sublayer of the SUL is a 50 nm thick soft magnetic layer of Fe₅₁Co₃₄Ta₁₀Zr₅. The top sublayer of the SUL is also a 50 nm thick soft magnetic layer of Fe₅₁Co₃₄Ta₁₀Zr₅. Other materials for the top and bottom sublayer of the SUL include other alloys of FeCoTaZr as well as CoTaZr, CoNbZr, CoFeB, and NiFe. Each of the top and bottom sublayers of the SUL may be between 25 and 75 nm thick. An AFC SUL is also described in U.S. Pat. No. 6,926,974. Additionally, the SUL may be a single SUL layer and not AFC coupled. Between the top and bottom layer of the SUL is an AFC coupling layer of Ru. The Ru layer is 0.5 nm thick and can be made between 0.25 and 1 nm thick. Additional materials for the for the AFC coupling layer include RuCo, RuCr and other Ru alloys.

Additionally, the media of FIG. 5a includes an exchange break layer (EBL) above the SUL. The EBL includes four sublayers. The first EBL sublayer is an alloy of CrTi₅₀ that is 2 nm thick. For this structure, the CrTi₅₀ is mainly used as a corrosion barrier. However, the first EBL sublayer also functions as part of the exchange breaking mechanism. Other materials for the first EBL sublayer include other alloys of CrTi. Further, since the first EBL sublayer is optional, it can be between 0-10 nm thick and preferably 1-2 nm thick. The second EBL sublayer, which is above the first EBL sublayer is a 5 nm thick layer of NiW₈. The NiW₈ orients the Ru layers as HCP [002]. Other materials for the second EBL sublayer include NiV, NiCr, NiFe, CuNb, NiNb, CuCr, CuW and other alloys of Ni of Cu. This sublayer can between 1 nm and 15 nm thick and preferably 6-8 nm thick. The second EBL sublayer is either slightly magnetic or non-magnetic. The third EBL sublayer, which is above the second EBL sublayer is a 7 nm thick layer of Ru sputtered at a low pressure of about 6 mTorr and may sputtered between 3-12 mTorr. Other materials for the third EBL sublayer include other Ru alloys such as RuSiO₂, RuCr and RuCo and can between 0 and 15 nm thick and preferably 6-8 nm thick. The third sublayer, though not necessary, helps to orient the top Ru layer. The fourth EBL sublayer, which is above the third EBL sublayer is a 10 nm thick layer of Ru sputtered at a high pressure such as 36 mTorr and can be sputtered between 20-50 mTorr. Other materials for the fourth EBL sublayer include Ru alloys including RuSiO₂, RuCr and RuCo and can between 4 nm and 30 nm thick. Preferably, the fourth EBL sublayer has a thickness between 9 and 13 nm. The sublayers of the EBL also help to control the grain size of the RL. Generally, the EBL can be between one and four layers thick. However, the EBL may include more than four layers.

Above the EBL of the media of FIG. 5a is the RL. The RL includes two layers. The first recording sublayer is comprised of (CoCr₁₇Pt₁₈)₉₂-(SiO₂)₈ and is 5 nm. Other materials for the first recording sublayer include CoCrPt and its alloys and can between 5 and 25 nm thick. The second recording sublayer is above the first recording sublayer. The second recording sublayer is comprised of (CoCr₁₃Pt₂₀)₉₂-(SiO₂)₈ and is 5 nm thick. Other materials for the second recording sublayer include CoCrPt and its alloys and can between 5 and 25 nm thick. Generally, the recording layer can be between one and four layers thick. However the total thickness of the RL is between 5 and 25 nm.

Above the RL of the media of FIG. 5a is an overcoat layer. In the media of FIG. 5a, the overcoat includes two sublayers. The first overcoat sublayer is a 3.7 nm layer of Carbon with N and H sputtered with the use of an ion beam. The second overcoat sublayer, which is above the first overcoat sublayer is a 0.6 nm layer of CNx that is sputtered in a normal manner, such as reactive sputtering. Other materials for the first and second overcoat sublayer include diamond like carbon (DLC) and SiN. The OC can between 0.25 nm and 5 nm thick. Generally, the overcoat layer can be between one and two layers thick. Above the overcoat layer is deposited a layer of lubricant such as Z-Dol and/or Z-Tetraol.

Media—Capped

FIG. 5b shows a second embodiment of a perpendicular media. Of course, the variations for the SUL, EBL, and OC for the media of FIG. 5a can be implemented with the capped media of FIG. 5b. The adhesion layer is a 5 nm thick layer of AlTi. The SUL is a tri-layer structure with a bottom and an upper soft magnetic sublayer, each of 56 nm Fe₅₁Co₃₄Ta₁₀Zr₅. The Ru AFC coupling layer is 0.5 nm thick and can be made between 0.25 and 1 nm thick. Other materials for the for the AFC coupling layer include RuCo, RuCr and other Ru alloys. The EBL is a quad-layer structure. The first sublayer is a CrTi₅₀ layer that is 2 nm thick. The second sublayer, above the first sublayer, is a NiW₈ layer that is 5 nm thick. The third and fourth sublayers, above the second sublayer, are 7 nm and 10 nm of Ru respectively. The magnetic layer includes a bottom magnetic sublayer of (CoCr₁₆Pt₁₈)₉₂-(SiO₂)₈ that is 8 nm thick and a top magnetic sublayer (cap) of CoCr₁₃Pt₁₉B₇ that is also 8 nm thick. These atomic percentages may be varied by about 25%. Other materials for the bottom magnetic sublayer in CoCrPt and its alloys, including oxides. These oxides include oxides of Ta, Si, Cu and Nb. The bottom magnetic sublayer is generally between 5 and 25 nm thick and preferably between 8 and 16 nm. Other materials for the capping layer include CoCr, CoCrPt, CoCrPtB, CoCrPtTa and their alloys. The cap layer is however generally not an oxide. Another specific embodiment of a cap is CoCr₁₉Pt₁₃B₇. The cap layer is sputtered at 6 mTorr and preferably at between 1 mTorr to 12 mTorr. The cap may be between 1 nm and 15 nm thick and preferably between 3 and 8 nm. The low pressure sputtering helps corrosion resistance of the media as well as improves the magnetic exchange coupling of the RL. The overcoat is also a dual layer structure. The first overcoat sublayer is a 3.7 nm layer of NCT. The second overcoat sublayer, which is above the first overcoat sublayer is a 0.6 nm layer of CNx. Above the overcoat layer is a layer of lubricant.

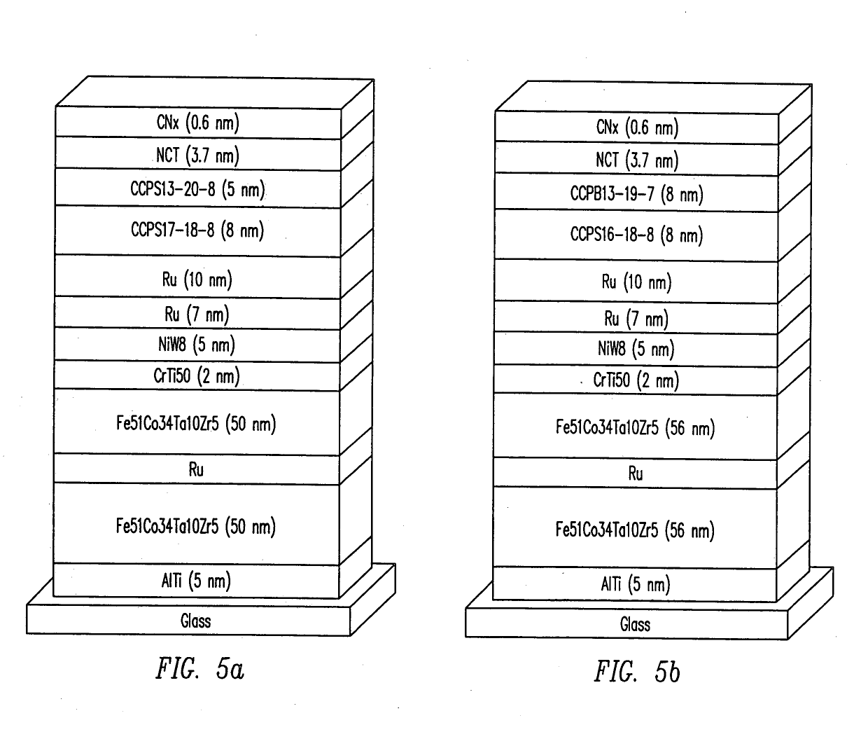

Novel processes are also used to fabricate perpendicular media. For instance, a piece of media can be cooled before deposition of a Ru or Ru alloy underlayer. The cooling of the disk can be to between 60 and 90 degrees centigrade or even below 60 degrees. The cooling increases the coercivity and SoNR of the disk as show in FIGS. 6a and 6b. The cooling steps can also be performed before any deposition of any sublayer of EBL or the RL. The cooling allows for improved growth of the EBL and RL.

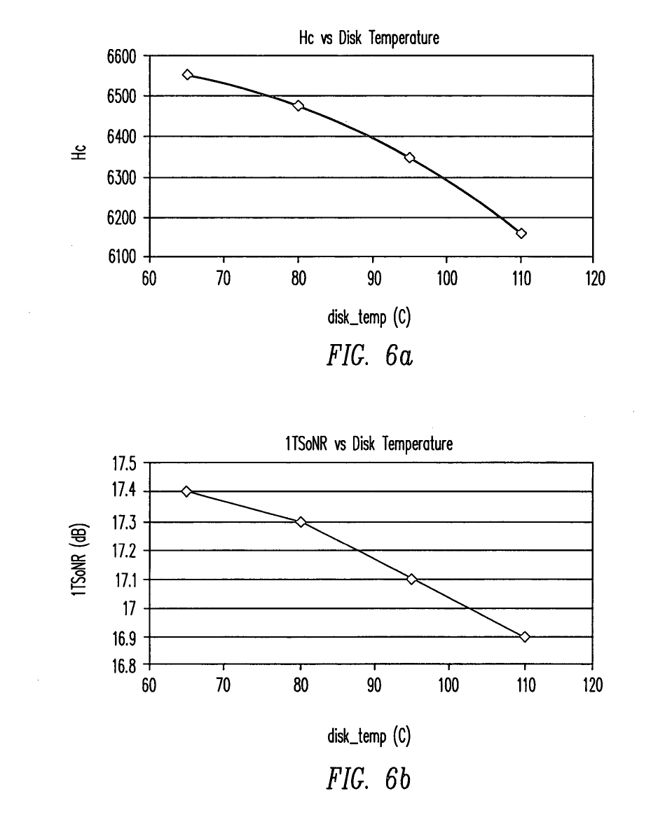

Further, a bias voltage may be applied to the substrate during the sputtering process of the RL. In particular, a bias contact may be achieved on the disk through a disk rotation device prior to the magnetic layer deposition, especially for a non-conductive substrate such as glass. FIG. 7 shows the dependence of the coercivity on the bias voltage applied to the disk during sputtering of the magnetic layers.

Cap media as described above has beneficial properties as described below in Table 2.

TABLE 2

| | media | | | | | | |
|---|---|---|---|---|---|---|---|
| disk | structure | Hc | Hn | SFD | Hs | Ho | KuV/kT |
| 5 nm Cap | Cap | 5508 | −2513 | 3190 | 9110 | 8840 | 96 |
| 8 nm Cap | Cap | 4870 | −2310 | 2565 | 8050 | 7745 | 115 |

In addition, the media of FIG. 5b is especially useful for perpendicular media. The upper sublayer (cap) of the recording layer includes high intergranular exchange, an Hk greater than 6000Oe and an Hc of less than 600. In general this type of media has the attribute that Hc<0.1 Hk. The lower sublayer of the recording layer has an Hk of greater than 60000Oe and an Hc of greater than 2750Oe or an Hc of greater than 3000Oe. An example of a magnetic layer that produces such properties is one with an upper sublayer of CoPt, CoPtCr or a CoPtCrX alloy where X is preferably B. In addition X can be Ta, Nb, Cu or V as well as other elements. Further other magnetic alloys of Fe, Co and Ni may also be used for the upper sublayer. The lower sublayer may be a CoPtCrSiO layer. The lower layer may also be a CoPtCrXO alloy, where X=Ta, Nb, V, or Ti. However, many other X oxides as well as CoPtCrO may also be used. Together, media with a recording layer with such higher and lower magnetic sublayers offers higher writeability, better SNR, improved thermal stability and improved ATI. The media of FIG. 5b also includes these properties when the lower oxide layer is built to have an Hc>6,000Oe.

The capped media also improves the SNR. It is useful to increase the signal to noise ratio (SNR) of the recording media. The SNR is to a first order proportional to 20 log(N^{1/2}), where N is the number of magnetic grains per area. Accordingly, increases in SNR can be accomplished by increasing N. However, the number of individual grains per unit area is limited by the minimum grain area required to maintain the thermal stability of the recorded magnetization. This limitation arises because the energy term protecting against thermal degradation is KV, where K is the anisotropy and V is the volume of an individual grain, and KV should be kept greater than a certain value, usually greater that about 70 kBT. If the grain area A is reduced, then V is reduced since V=At, where t is the grain height (film thickness). Thus reductions in A reduces KV leading to possible thermal stability problems. One approach to prevent this problem is to proportionally increase K as V is decreased. However, this approach is limited by the available writing fields produced by the recording head. The field necessary to write the media is represented by the term H₀, which is proportional to K/M, where M is the grain magnetization. Therefore, increasing K will increase H₀ and may prevent the media from being able to be written by the recording head. In order to ensure reliable operation of a magnetic recording system the media should have high enough SNR, be writable, and be thermally stable. Such a film also would reduce the length scale of the magnetization fluctuations without encountering thermal stability problems.

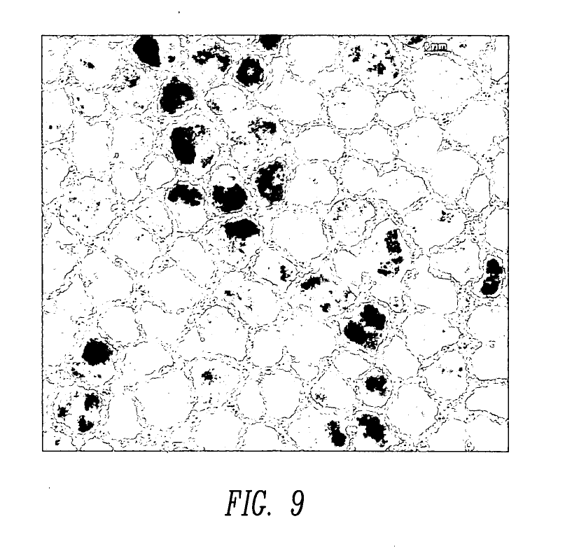

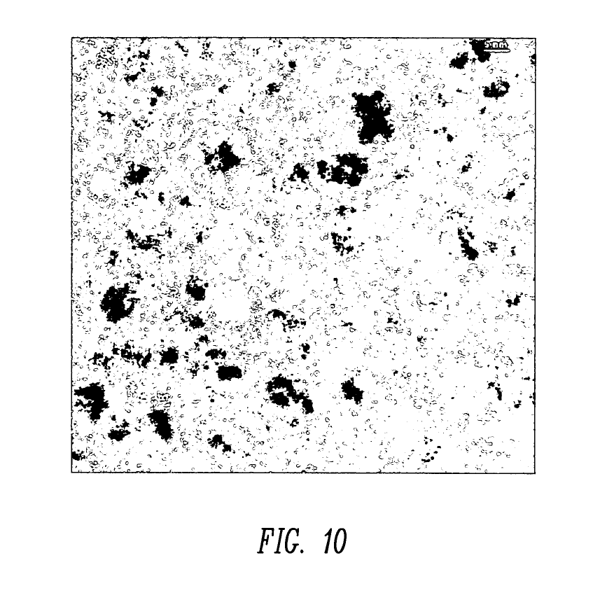

The media of FIG. 5b includes an RL that overcomes these limitations. In this RL structure, the magnetic recording layer consists of two layers. The first uses an alloy that contains grains with a grain area of about 8 nm and a grain anisotropy that would be stable at a thickness of about 14 nm. The plane view TEM image of an embodiment of such a layer is shown in FIG. 9. The second layer consists of grains that are much smaller than the grains of the first layer. An embodiment of such a layer is shown in FIG. 10. The microstructure of this layer consists of grains that are about ¼ the size of the grains of the layer below it. These grains have some contact with each other such that there is some amount of intergranular exchange present. In perpendicular media it is desirable to have some amount of intergranular exchange present. The small size of these grains allows for variations in the magnetization directions of these grains on a much smaller scale than would be possible using a layer of the prior art. However, because they are in direct contact and directly coupled to the layer below, they are thermally stable. This layer also allows for control of the intergranular exchange in the overall structure in a much more uniform way than would be possible in the prior art structure. These two improvements allow the transition to be more accurately placed in the media which allows for improved signal to noise ratio over the prior art. This is similar to increasing the number of grains per area, but does not have the problems in stability that one would encounter without this structure as in the prior art. The media of FIGS. 9-10 includes a cap of CoPtl₄Cr₁₉B₇ (FIG. 10) and a lower magnetic sublayer of (CoPt₁₈Cr₁₇)₉₂-(SiO₂)₈ (FIG. 9).

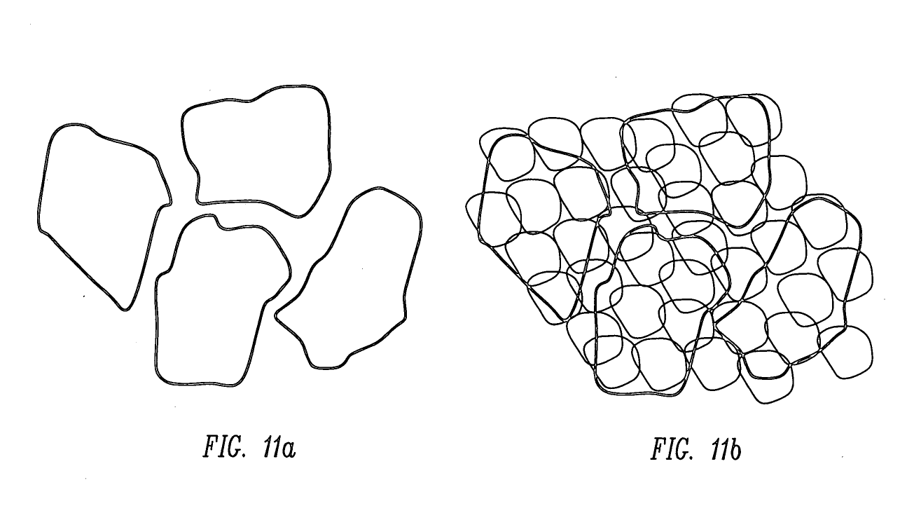

A schematic representation of these layers is shown in FIG. 11a-b. FIG. 11a is a representation of the grains of the lower magnetic sublayer. FIG. 11b is a representation of the media when the grains of the cap layer are sputtered on top of the lower magnetic sublayer. The top non oxide layer (cap) is sputtered at low pressure (generally less than 10 mTorr). The oxide, bottom recording sublayer, is typically sputtered at mid range pressures like 12 mTorr.

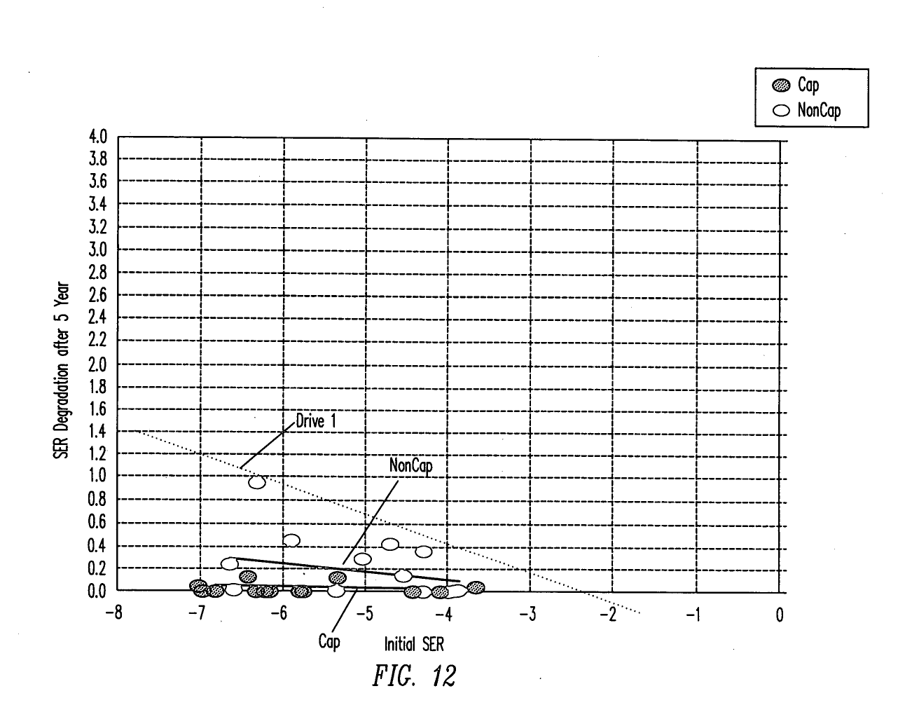

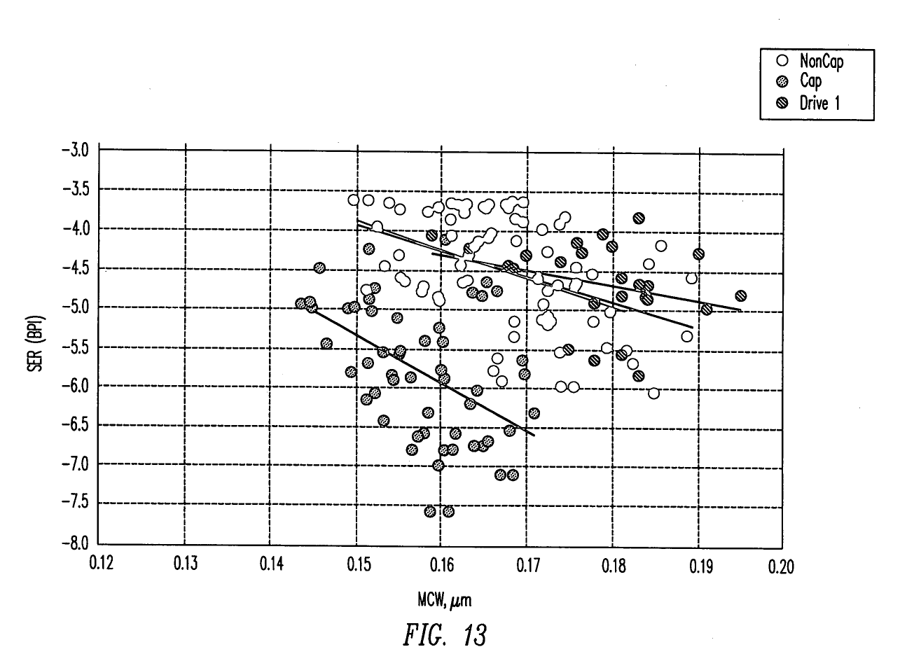

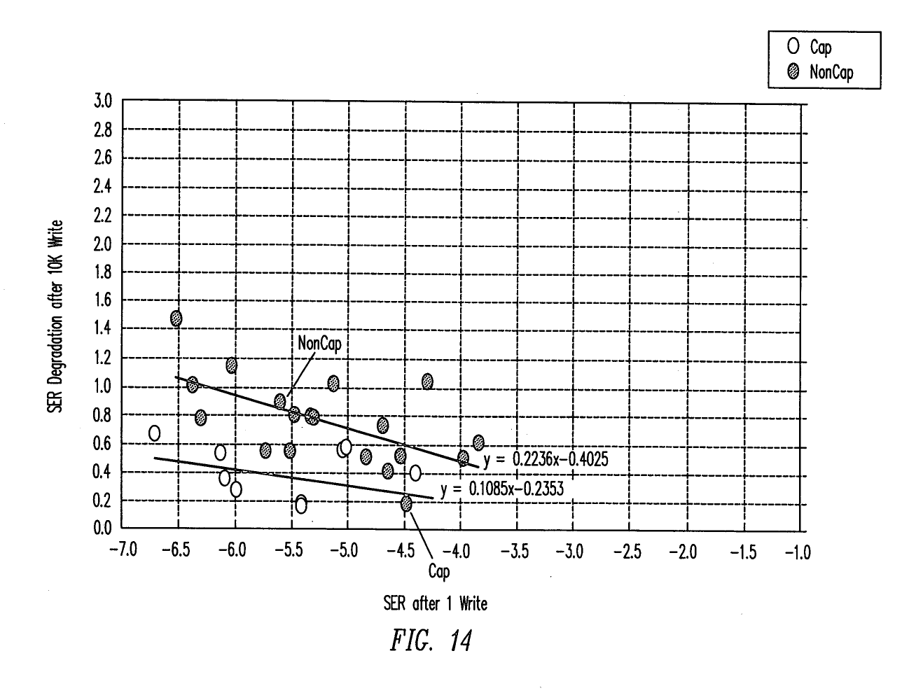

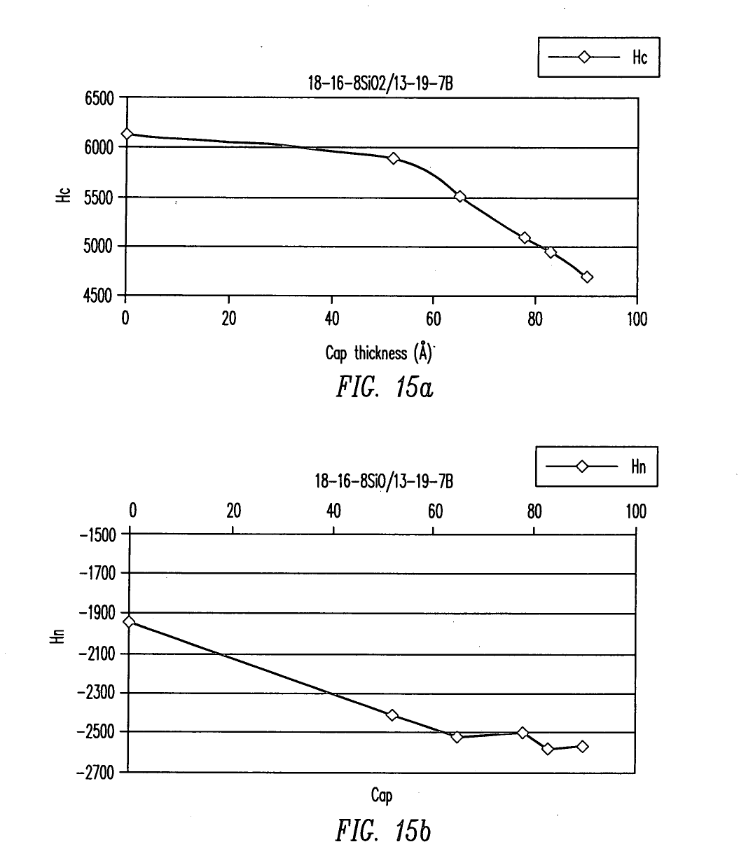

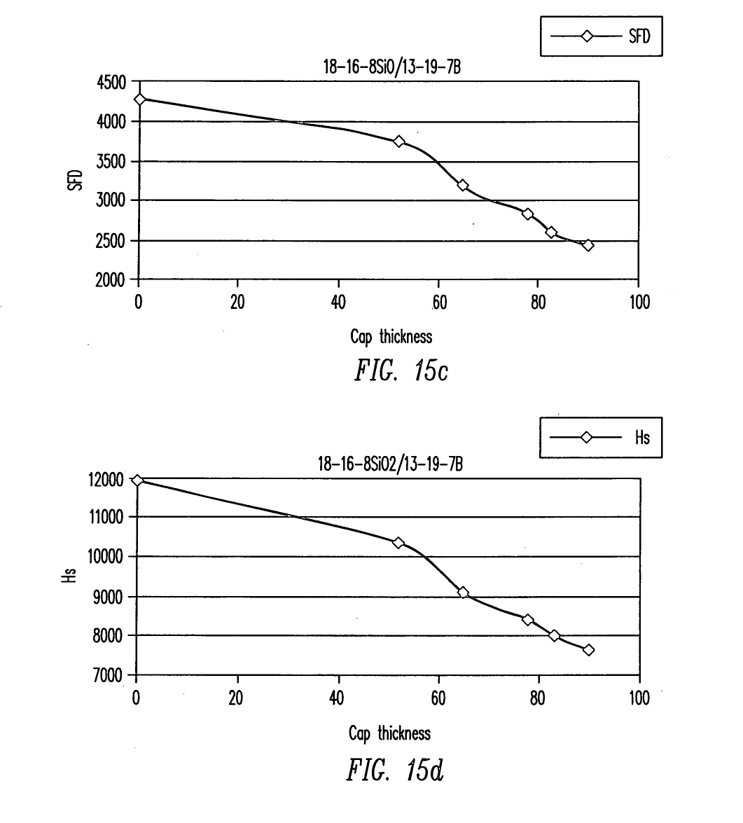

FIGS. 12-16 additionally show the advantages of capped media. FIG. 12 is a graph showing thermal decay improvement of capped media over non-capped media. FIG. 13 is a graph showing BER improvement of capped media over non-capped media. FIG. 14 is a graph showing ATI improvement of capped media over and non-caped media. FIG. 15 shows the dependence of coercivity Hc, switching field distribution (SFD), nucleation field (Hn) and saturation field (Hs) on CoCrPtB cap layer thickness. Adding a cap layer of CoCrPtB alloy is generally beneficial for the parameters SFD, Hn and Hs, which improves significantly the recording properties such as SNR and thermal stability of the media. The proper selection of Hc in the cap media structure is also flexible to match the optimum head design in recording system. FIG. 16 shows the comparison of SoNR performance of cap and non-cap perpendicular magnetic recording media and demonstrates the improvement in SoNR using a capped media.

### Exchange Break Layer Embodiment

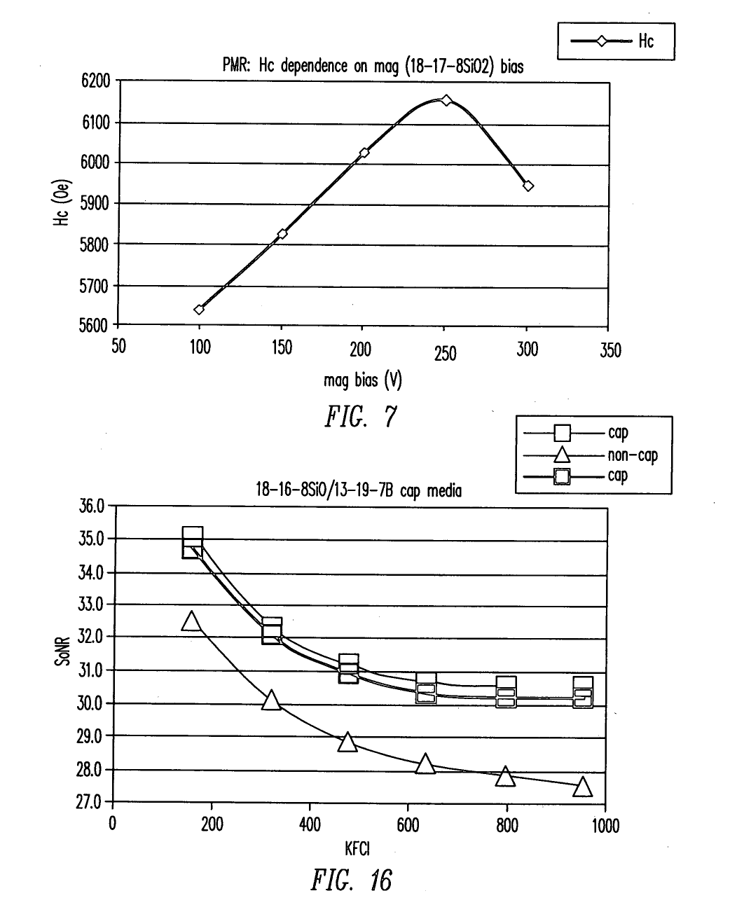

An embodiment of an EBL can include a dual layer structure as shown in FIG. 8. This EBL structure includes a magnetic pre-exchange break sublayer (MPEB) below a true exchange break sublayer (TEB). The TEB facilitates decoupling of the SUL from the RL. In terms of its magnetic properties, the MPEB becomes effectively part of the SUL to which it is coupled either by direct exchange coupling or by dipole-dipole interaction during the write process. It can be estimated that TEB layers of 1-2 nm of Ru are sufficient to achieve magnetic decoupling between the SUL (or the MPEB being part of the overall SUL structure) and the RL. The advantage of this structure is that the SUL and RL are now effectively closer together which allows higher write fields, higher write field gradients and an overall more effective magnetic flux guiding geometry for the recording process.

Preferably, the MPEB is made from a magnetic onset-layer material that is also suitable as a template for RL growth with an easy axis substantially along the c-axis. Suitable materials for the MPEB include Co—, CoRu—, and CoRuCr— alloys with Co contents of greater than or equal to 50 at. %. Further, the MPEB alloys can include further segregants like SiO₂ for the purpose of providing a more suitable growth template. The MPEB is 2-40 nm in thickness and more preferably between 4-20 nm. Preferably, the TEB is made of a non-ferromagnetic material that enables decoupling of the RL from the MPEB and SUL while allowing for growth of the RL. Possible implementations of the TEB include Ru, RuCo and RuCoCr where the Co content is less than or equal to 45 at. %. Further compound materials using Ru, RuCo and RuCoCr as well as SiO₂ or similar oxide and segregant materials can be used. Again, for these compounds, the Co content is less than or equal to 45 at. %. The TEB can be between 1-10 nm with 1-5 nm of thickness being preferred. Further, the TEB or MPED may have multiple sublayers. For instance the TEB may be a dual Ru layer sputtered at different pressures and/or rates.

The media, methods and structures described herein may also be used in other applications as well, such as tape or patterned disk media.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A perpendicular magnetic recording medium comprising:
a substrate;
a soft magnetic underlayer;
an exchange break layer; and
a perpendicular magnetic recording layer, wherein the exchange break layer comprises at least three layers.

2. The perpendicular recording medium of claim 2, wherein the exchange break layer comprises at least four layers.

3. The perpendicular recording medium of claim 1, wherein the at least three layers of the exchange break layer comprise at least two layers of Ru or Ru alloys that are sputtered at different pressures.

4. The perpendicular recording medium of claim 3, wherein
a bottom layer of the at least two Ru or Ru alloys is sputtered at between 3-12 mTorr and a top layer of the at least two Ru or Ru alloys is sputtered at between 20-50 mTorr.

5. The perpendicular recording medium of claim 3, wherein the bottom layer of the at least two Ru or Ru alloys is between 0.5 and 15 nm and the top layer of the at least two Ru or Ru alloys is between 4 and 30 nm.

6. The perpendicular recording medium of claim 1, wherein the at least three layers of the exchange break layer comprise at least one layer of Ru or Ru alloy and at least one layer of a material that orients the at least one layer of Ru or Ru alloy as HCP [002].

7. The perpendicular recoding medium of claim 6, wherein the layer of material that orients the at least one layer of Ru or Ru alloy comprises at least one of NiW, NiV, NiCr, NiFe, CuNb, NiNb, CuCr and CuW.

8. The perpendicular recoding medium of claim 6, wherein the layer of material that orients the at least one layer of Ru or Ru alloy comprises at least one of Cu and Ni.

9. The perpendicular recording medium of claim 1, wherein the perpendicular magnetic recording layer includes at least a first and a second layer, wherein the first layer is above the second layer.

10. The perpendicular recording medium of claim 9, wherein the second layer of the perpendicular magnetic recording layer comprises an oxide.

11. The perpendicular recording medium of claim 10, wherein the first layer of the perpendicular magnetic recording layer comprises an oxide.

12. The perpendicular recording medium of claim 10, wherein the first layer of the perpendicular magnetic recording layer does not include an oxide.

13. A perpendicular magnetic recording medium comprising:
a substrate;
a soft magnetic underlayer;
an exchange break layer comprising a top sublayer and a bottom sublayer; and
a perpendicular magnetic recording layer, wherein
the top sublayer of the exchange beak layer comprises a magnetic pre-exchange break layer and the top sublayer of the exchange break layer comprises a true exchange break layer.

14. The perpendicular magnetic recording medium of claim 13, wherein the top sublayer of the exchange break layer comprises Ru and the bottom sublayer of the exchange break layer comprises CoRu.

15. The perpendicular magnetic recording medium of claim 13, wherein the top sublayer is 1-2 nm in thickness.

16. The perpendicular magnetic recording medium of claim 14, wherein the concentration of Co in the bottom sublayer is at least 50 at. %.

17. The perpendicular magnetic recording medium of claim 14, wherein the bottom sublayer includes a segregant.

18. The perpendicular magnetic recording medium of claim 17, wherein the segregant is SiO₂.

19. The perpendicular magnetic recording medium of claim 14, wherein the bottom sublayer is between 2 and 40 nm.

20. The perpendicular magnetic recording medium of claim 14, wherein the top sublayer comprises CoRu and the concentration of Co is less than or equal to 45 at. %.

21. The perpendicular recording medium of claim 13, wherein the perpendicular magnetic recording layer includes at least a top and a bottom layer.

22. The perpendicular recording medium of claim 21, wherein the bottom layer of the perpendicular magnetic recording layer comprises an oxide.

23. The perpendicular recording medium of claim 22, wherein the top layer of the perpendicular magnetic recording layer comprises an oxide.

24. The perpendicular recording medium of claim 22, wherein the top layer of the perpendicular magnetic recording layer does not include an oxide.

25. A perpendicular magnetic recording medium comprising:
a substrate;
a soft magnetic underlayer;
an exchange break layer including at least three layers; and
a perpendicular magnetic recording layer including at least a top and a bottom layer, wherein
the bottom layer of the perpendicular magnetic recording layer comprises an oxide; and the at least three layers of the exchange break layer comprise at least one layer of Ru or Ru alloy and at least one layer of a material that orients the at least one layer of Ru or Ru alloy as HCP [002].

26. The perpendicular recording medium of claim 25, wherein the magnetic layers are sputtered while a bias voltage is applied to the substrate.
